(19) United States
(12) Patent Application Publication
(10) Pub. No.: US 2026/0320705 A1
(43) Pub. Date: Oct. 15, 2026

(54) Systems and Methods for Applying Guidelines to Data Objects Utilizing Multi-Agent Architecture

(71) Applicant: Procore Technologies, Inc., Carpinteria, CA (US)

(72) Inventors: James Adam Pita, Middletown, MD (US); Asadali Lalani, Houston, TX (US); Amanda Rae Tannenbaum, New Orleans, LA (US); Joshua Alexander Newland, Walnut Creek, CA (US); Justin Jude Levy, Austin, TX (US); Rachel Konderla, College Station, TX (US)

(21) Appl. No.: 19/180,078

(22) Filed: Apr. 15, 2025

(51) Int. Cl. G06Q 50/08; G06Q 10/10

(52) U.S. Cl. CPC G06Q 50/08; G06Q 10/103

(57) ABSTRACT

An example computing platform is configured to (i) receive an indication of a set of data element values for a new data object to be created within a construction management software application, (ii) determine a set of guidelines that correspond to the new data object to be created, (iii) utilize a guideline verification agent to determine whether the new data object is in compliance with the set of guidelines, (iv) determine that the new data object is not in compliance with at least one guideline of the set of guidelines, and (v) based on determining that the new data object is not in compliance with the at least one guideline, utilize a set of refiner agents to correct the new data object so that the new data object is in compliance with the set of guidelines.

### BACKGROUND

Increasingly, parties involved in construction projects are using software applications to manage those construction projects. One example of such a software application is the software-as-a-service (Saas) application for construction management offered by Procore Technologies, Inc. (“Procore”), who is the current applicant. Using construction management software applications such as these, parties can create a digital representation of a given construction project that is to be managed and then create, store, view, and/or interact with various types of digital project data associated with the given construction project. Such digital project data may include specifications, drawings, photos, building information model (BIM) files, requests for information (RFIs), punch lists (e.g., which list work that has not yet been completed or has been completed incorrectly), risk management plans, safety plans, work breakdown structures, change orders, inspection documents (e.g., which record information about the results of inspections), construction submittals (e.g., information that a responsible contractor provides to a general contractor and/or submits to a design team for approval of equipment and/or materials), construction site observation reports, project management records (e.g., project schedules, schedule items, and project budgets), third-party records (e.g., applicable zoning restrictions, real-estate title records and purchase records, records of public hearings pertinent to the given construction project), directories, invoices, timesheets, meeting minutes, sensor data, and daily logs (e.g., which record information about each day work is done at a work site of the construction project), among many other examples of project data that may be stored for a construction project.

### SUMMARY

Disclosed herein is new software-based artificial intelligence (AI) architecture that utilizes AI agents to create and apply guidelines for assisting users to create data objects that are in compliance with the guidelines.

In one aspect, the disclosed technology may take the form of a method that involves (i) receiving an indication of a set of data element values for a new data object to be created within a construction management software application, (ii) determining a set of guidelines that correspond to the new data object to be created, (iii) utilizing a guideline verification agent to determine whether the new data object is in compliance with the set of guidelines, (iv) determining that the new data object is not in compliance with at least one guideline of the set of guidelines, and (v) based on determining that the new data object is not in compliance with the at least one guideline, utilizing a set of refiner agents to correct the new data object so that the new data object is in compliance with the set of guidelines.

In some examples, each guideline of the set of guidelines corresponds to a respective data element for the new data object.

Further, in some examples, each guideline of the set of guidelines comprises (i) a title, (ii) a rule, and (iii) a scoring criterion.

Still further, in some examples, the method may involve causing an indication of a score of the new data object to be presented to a user of a client device, wherein the indication of the score indicates that the new data object is not in compliance with the set of guidelines, and causing an indication of a recommendation for bringing the new data object into compliance with the set of guidelines to be presented to the user of the client device.

Still further, in some examples, utilizing the guideline verification agent to determine whether the new data object is in compliance with the set of guidelines may involve causing the guideline verification agent to collaborate with a set of subagents to generate a prompt for a generative AI model to determine whether the new data object is in compliance with the set of guidelines.

Still further, in some examples, the set of subagents includes at least one of (i) a subagent that is configured for a given type of the new data object or (ii) a subagent that is configured for a given software tool of the construction management software application that is used to create the new data object.

Still further, in some examples, the set of refiner agents includes at least one of (i) a refiner agent that is configured for a given type of the new data object or (ii) a refiner agent that is configured for a given software tool of the construction management software application that is used to create the new data object.

Still further, in some examples, utilizing the guideline verification agent to determine whether the new data object is in compliance with the set of guidelines may involve utilizing the guideline verification agent to apply the set of guidelines to the new data object on a by-data element basis.

Still further, in some examples, the method may involve, after correcting the new data object, causing the new data object to be stored within a data store accessible to the computing platform.

Still further, in some examples, the method may involve utilizing a guideline creation agent to create the set of guidelines.

In another aspect, the disclosed technology may take the form of a computing platform comprising at least one processor, at least one non-transitory computer-readable medium, and program instructions stored on the at least one non-transitory computer-readable medium that are executable by the at least one processor such that the computing platform is configured to carry out the functions of the aforementioned method.

In yet another aspect, the disclosed technology may take the form of a non-transitory computer-readable medium comprising program instructions stored thereon that are executable to cause a computing platform to carry out the functions of the aforementioned method.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawings.

### BRIEF DESCRIPTION OF THE DRAWINGS

FIG. 1 depicts an example network configuration in which example described herein may be implemented.

FIG. 2 shows a block diagram that depicts example functionality for implementing a software-based AI architecture to create a new guideline for evaluating data objects created via a construction management software application, in accordance with the present disclosure.

FIG. 3 shows an example of a user interface that may be presented for creating new guidelines, in accordance with the present disclosure.

FIG. 4 shows a block diagram that depicts example functionality for implementing the software-based AI architecture to verify and refine new data objects that are being created within the construction management software application, in accordance with the present disclosure.

FIG. 5A shows an example of a user interface that may be presented for creating and verifying a new data object, in accordance with the present disclosure.

FIG. 5B shows an example of a user interface that may be presented for refining a new data object, in accordance with the present disclosure.

FIG. 6 illustrates a simplified block diagram of some structural components that may be included in an example computing platform that may be configured to perform the platform-side functions disclosed herein.

FIG. 7 illustrates a simplified block diagram of some structural components that may be included in an example client device that may be configured to perform some of the client-side functions disclosed herein.

### DETAILED DESCRIPTION

The following disclosure refers to the accompanying figures and several examples. One of ordinary skill in the art would understand that such references are for the purpose of explanation only and are therefore not meant to be limiting. Part or all of the disclosed systems, devices, and methods may be rearranged, combined, added to, and/or removed in a variety of manners, each of which is contemplated herein.

As noted above, construction management today is often performed through the use of software applications, such as the software application for construction management provided by Procore Technologies, Inc.®, the applicant of the present disclosure. These construction management software applications generally provide users with the ability to create, store, view, and/or interact with various types of digital data related to a construction project. In practice, these construction management software applications may take various forms.

As one possible implementation, a construction management software application may include both front-end software (e.g., a web application, desktop application, or mobile application) running on client devices that are accessible to individuals associated with construction projects (e.g., contractors, project managers, architects, engineers, designers, etc.) and back-end software running on a back-end computing platform (sometimes referred to as a “cloud” platform) that interacts with and/or drives the front-end software, and which may be operated (either directly or indirectly) by the provider of the front-end software. This form of a software application may be referred to as a client-server application or a software-as-a-service (Saas) application, among other possibilities. As another possible implementation, a construction management software application may include front-end software that runs on client devices without interaction with a back-end computing platform. These construction management software applications may take other forms as well.

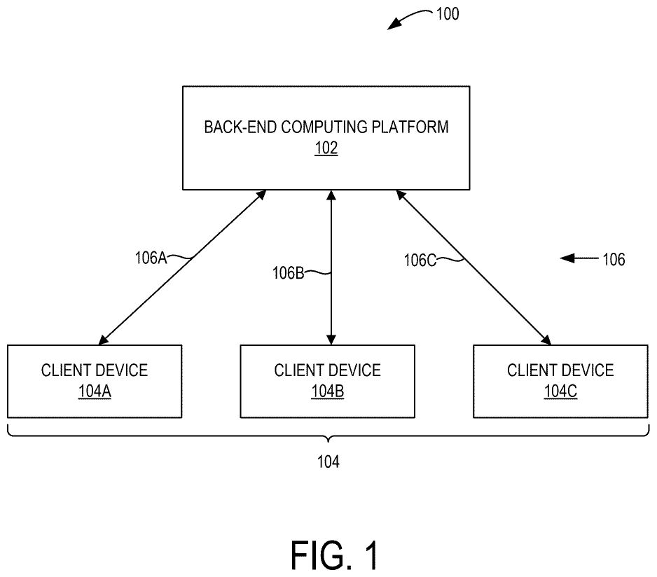

Turning now to the figures, FIG. 1 depicts an example network environment 100 in which a construction management software application may be implemented. As shown in FIG. 1, the network environment 100 includes a back-end computing platform 102 that may be communicatively coupled to one or more client devices 104, which as shown includes the client device 104A, the client device 104B, and the client device 104C. Although the client devices 104 are depicted by three devices as shown for the sake of simplicity in illustration, it should be understood that the client devices 104 may represent more or less than three devices without departing from the spirit and scope of this disclosure.

Broadly speaking, the back-end computing platform 102 may comprise one or more computing systems that have been provisioned with back-end software for a construction management software application, which may include program code for carrying out one or more of the platform-side functions disclosed herein. The one or more computing systems of the back-end computing platform 102 may collectively comprise some set of physical computing resources (e.g., one or more processors, data storage system, communication interfaces, etc.), which may take various forms and be arranged in various manners.

For instance, as one possibility, the back-end computing platform 102 may comprise computing infrastructure of a public, private, and/or hybrid cloud (e.g., computing and/or storage clusters) that has been provisioned with back-end software for the construction management software application. In this respect, the entity that owns and operates the back-end computing platform 102 may supply its own cloud infrastructure or obtain the cloud infrastructure from a third-party provider of “on demand” computing resources, such as Amazon Web Services (AWS) or the like. As another possibility, the back-end computing platform 102 may comprise one or more dedicated servers that have been provisioned with back-end software for the construction management software application.

Further, in practice, the back-end software installed at the back-end computing platform 102 may be implemented using any of various software architecture styles, examples of which may include a microservices architecture, a service-oriented architecture, and/or a serverless architecture, among other possibilities, as well as any of various deployment patterns, examples of which may include a container-based deployment pattern, a virtual-machine-based deployment pattern, and/or a Lambda-function-based deployment pattern, among other possibilities.

Further yet, although not shown in FIG. 1, the back-end software installed at the back-end computing platform 102 may interact with a data storage layer of the back-end computing platform 102, which may comprise data stores of various different forms, examples of which may include relational databases (e.g., Online Transactional Processing (OLTP) databases), NoSQL databases (e.g., columnar databases, document databases, key-value databases, graph databases, etc.), file-based data stores (e.g., Hadoop Distributed File System), object-based data stores (e.g., Amazon S3), data warehouses (which could be based on one or more of the foregoing types of data stores), data lakes (which could be based on one or more of the foregoing types of data stores), message queues, or streaming event queues, among other possibilities.

The back-end computing platform 102 may comprise various other components and take various other forms as well.

In turn, the client devices 104 may each be any computing device that is capable of running front-end software of the construction management software application, which may include program code for carrying out the client-side functions disclosed herein. In this respect, the client devices 104 may each include hardware components such as one or more processors, computer-readable mediums, communication interfaces, and input/output (I/O) components (or interfaces for connecting thereto), among others, as well as software components that facilitate the client device's ability to run the front-end software (e.g., operating system software, web browser software, etc.). As representative examples, the client devices 104 may each take the form of a desktop computer, a spatial computer, a laptop, a netbook, a tablet, a smartphone, and/or a personal digital assistant (PDA), among other possibilities.

As further depicted in FIG. 1, the back-end computing platform 102 is configured to interact with the client devices 104 over respective communication paths 106, of which communication paths 106A, 106B, and 106C are shown as examples. In this respect, each respective communication path 106 between the back-end computing platform 102 and one of the client devices 104 may generally comprise one or more communication networks and/or communications links, which may take any of various forms. For instance, each respective communication path 106 with the back-end computing platform 102 may include any one or more of Personal Area Networks (PANs), Local-Area Networks (LANs), Wide-Area Networks (WANs) such as the Internet or cellular networks, cloud networks, and/or point-to-point links, among other possibilities. Further, the communication networks and/or links that make up each respective communication path 106 with the back-end computing platform 102 may be wireless, wired, or some combination thereof, and may carry data according to any of various different communication protocols. Further yet, communications over each respective communication path 106 could be carried out via an Application Programming Interface (API), among other possibilities. Still further, although not shown, the respective communication paths 106 between the client devices 104 and the back-end computing platform 102 may also include one or more intermediate systems. For example, it is possible that the back-end computing platform 102 may communicate with a given client device 104 via one or more intermediary systems, such as a host server (not shown). The respective communication paths 106 between the back-end computing platform 102 and the client devices 104 may take other forms as well.

Although not shown in FIG. 1, the back-end computing platform 102 may also be configured to receive data, such as data related to a construction project, from one or more external data sources, such as an external database and/or another back-end computing platform or platforms. Such data sources—and the data output by such data sources—may take various forms.

It should be understood that the network environment 100 depicted in FIG. 1 is one example of a network environment in which a construction management software application may be implemented. Numerous other arrangements are possible and contemplated herein. For instance, other network configurations may include additional components not pictured and/or more or fewer of the pictured components.

When a given party (e.g., a company or individual involved in the construction industry) wishes to utilize an existing construction management software application, the given party may begin by (i) creating an account with the construction management software application and (ii) adding a set of one or more individuals associated with the given party as users on the given party's account. Thereafter, the construction management software application may enable the users of the given party to create, store, view, and/or interact with digital data related to construction projects that involve the given party.

For instance, for each of one or more construction projects that involve the given party, the construction management software application may enable users of the given party to create a new project workspace for the construction project (or join an existing project workspace for the construction project that was previously created) and then (ii) create, store, view, and/or interact with any of various types of digital data objects related to the construction project, which may be referred to herein as “project-related data objects” or simply as “data objects.”

In practice, each different type of project-related data object that is supported by a construction management software application may be designed to serve a particular purpose within the construction management software application and may comprise a particular set of data elements that facilitate that particular purpose. For instance, a first type of project-related data object may be designed to serve a first purpose within the construction management software application and may comprise a first set of data elements, a second type of project-related data object may be designed to serve a second purpose within the construction management software application and may comprise a second set of data elements that differs from the first set of data elements, and so on for each of the other types of project-related data objects. In this way, the users of the construction management software application may utilize different types of project-related data objects to manage different aspects of the construction project.

As some representative examples, the types of project-related data objects that may be supported by a construction management software application may include submittal data objects (e.g., a data object comprising data that represents an item submitted by a responsible contractor to a general contractor of a construction project for review and approval), schedule-item data objects (e.g., a data object comprising data that represents a task, event, or milestone within a schedule for a construction project), photo data objects (e.g., a digital image), observations data objects (e.g., a data object comprising data that represents observed conditions and/or associated effects of said conditions during a construction project at a point in time during the course of the construction project), punch item data objects (e.g., a data object comprising data that represents a work item on a construction project that must be completed to conform to a construction project's contract specifications), daily log data objects (e.g., a data object comprising data that represents construction activity within a given timeframe, such as a day), RFI data objects (e.g., a data object comprising data that represents request for information from one user/party to another user/party and/or the information provided in response to said request), and/or inspection data objects (e.g., a data object comprising data that represents an inspection of a site at some point in time during the course of a construction project), among other types of project-related data objects. In some cases, the construction management software application may also support other types of data objects that are not specific to any particular construction project, such as data objects related to the party or a particular user of the party, among other possibilities.

In at least some implementations, the software features for creating, storing, viewing, and/or interacting with the different types of project-related data objects that are supported by a construction management software application may be arranged into different software “tools” that each correspond to a different type of project-related data object. For instance, a construction management software application may include a “Submittals” tool for creating, storing, viewing, and/or interacting with submittal data objects, a “Schedule” tool for creating, storing, viewing, and/or interacting with schedule-item data objects, a “Task” tool for creating, storing, viewing, and/or interacting with schedule-item data objects, a “Photos” tool for creating, storing, viewing, and/or interacting with photo data objects, an “Observations” tool for creating, storing, viewing, and/or interacting with observations data objects, a “Punch Items/Lists” tool for creating, storing, viewing, and/or interacting with punch list and/or punch item data objects, a “Daily Logs” tool for creating, storing, viewing, and/or interacting with daily log data objects, an “RFIs” tool for creating storing, viewing, and/or interacting with RFI data objects, and/or an “Inspections” tool for creating, storing, viewing, and/or interacting with inspections data objects, among various other examples of software tools that may be included within a construction management software application. However, in other implementations, the software features for creating, storing, viewing, and/or interacting with the different types of data objects that are supported by a construction management software application may be arranged in other manners (e.g., software features that operate across multiple different types of data objects) that are not based solely on a software tools paradigm.

One problem of existing construction management software applications is that the information quality of the data objects that are created within a given construction management software application is dependent on the knowledge and/or experience of the user that creates the data object. However, there is very little, if any, quality control of data objects being created in construction management software applications today. Users creating data objects may not know what information to include in the data objects and/or how best to convey that information, and as a result may create deficient data objects that omit relevant information, are unclear or inaccurate, etc. These issues cause further problems downstream, as users tasked with using the data objects (e.g., to respond to an RFI) may not have the information needed to properly use the data objects. For instance, if an RFI data object is created without any indication of who is responsible for reviewing the RFI, then it may be difficult for the RFI data object to be addressed by a relevant party. To the extent that issues caused by deficient data objects may be resolved (e.g., by identifying deficient data objects, identifying from whom to obtain any clarified or missing information, obtaining the clarified or missing information, updating the data objects, etc.), the process of doing so is time-consuming and resource-intensive. The lack of quality control of data objects being created in construction management software applications today results in other inefficiencies and causes other problems as well.

One effort to provide some quality control of data objects has been to utilize customer support of construction management software applications in the form of live chats, blogs, discussion boards, and the like to assist users in creating complete data objects. However, given the volume of users of construction management software applications and the breadth of different types of data objects that may be created, it is impractical for customer support to offer personalized guidance to every user to ensure that quality data objects are created.

To address these and other technical problems associated with existing construction management software applications, disclosed herein is a software-based artificial intelligence (AI) architecture that utilizes AI agents to create and apply guidelines for assisting users to create data objects that are in compliance with the guidelines. Data objects that are in compliance with the guidelines may enable users tasked with creating, reviewing, or otherwise using the data objects to do so without the difficulties caused by the lack of quality control described above.

The guidelines discussed herein may include various components. For instance, the components of a given guideline may include (i) a title for the given guideline, (ii) a rule for determining whether data objects are in compliance with the given guideline, (iii) a scoring criterion, which may be used to determine scores for data objects indicating whether or not (and possibly to what extent) the data objects comply with the given guideline, and (iv) a recommendation, which may include a description of what recommendations should be provided to a user when verifying data objects against the given guideline. In some implementations, a given guideline may include multiple of one or more of these components, such as multiple recommendations and/or multiple scoring criteria, among other possibilities. Further, in some implementations, a given guideline might not include one of these components. For instance, a given guideline may have a title, a rule, and a scoring criterion, but no recommendation. Other examples are also possible.

Guidelines may be created for and applied to any of the types of data objects previously described. Further, the guidelines may be applied to data objects in various ways. As one possibility, guidelines may be applied to data objects on a data element by data element basis. In line with the previous discussion, each type of data object may include a respective set of data elements. Using RFI data objects as an example, the set of data elements that may be included in RFI data objects may include a “RFI number” data element, a “Subject” data element, a “Status” data element, a “Created By” data element, a “Date Initiated” data element, a “RFI Manager” data element, a “Distribution List” data element, a “Assignees” data element, a “Due Date” data element, a “Received From” data element, a “Responsible Party” data element, a “Drawing Number(s)” data element, a “Linked Drawing(s)” data element, a “Specification Section” data element, a “Location” data element, a “Schedule Impact” data element, a “Cost Code” data element, a “Cost Impact” data element, a “Reference” data element, a “Ball in Court” data element, a “Question(s)” data element, and/or a “Response(s)” data element, among other possibilities. According to this example, there may be one or more guidelines that may be applied to the “RFI number” data element, one or more guidelines that may be applied to the “Subject” data element, and so forth. As one example, there may be a guideline that may be used to evaluate whether data objects include a value for the “Responsible Party” data element that corresponds to a party that is associated with the construction project for which the data objects are being created. As another example, there may be a first guideline that may be used to evaluate whether data objects include a value for the “Question(s)” data element that includes at least 100 characters, as well as a second guideline that may be used to evaluate whether data objects include a value for the “Question(s)” data element that meet a certain clarity level, which may be defined in various ways. Various other examples may also exist.

As another possibility, guidelines may be applied to data objects based on more than one data element. As one example, a guideline may be used to evaluate whether data objects include a value for the “Subject” data element that is relevant to a value entered in the “Question(s)” data element. As another example, a guideline may be used to evaluate whether data objects include “Responsible party” data element that is, in fact, responsible for the subjects referenced in the data objects. Various other examples may also exist.

The guidelines may be applied to data objects in various other ways.

At a high level, the disclosed software-based AI architecture may be encoded within a construction management software application and may comprise (i) a guideline creation agent configured to create guidelines for evaluating data objects that are created within a construction management software application, (ii) a guideline verification agent configured to reference the created guidelines to evaluate whether new data objects being created within the construction management software application are in compliance with corresponding guidelines, and (iii) one or more refiner agents configured to reference the created guidelines and refine non-compliant data objects being created within the construction management software application to be in compliance with corresponding guidelines. The disclosed software-based AI architecture may include other agents as well. The functionality of each of these AI agents are described in further detail below.

The disclosed software-based AI architecture may improve upon the existing construction management software applications in various ways. For example, the disclosed software-based AI architecture may be utilized to assist users in creating guidelines for evaluating new data objects, as well to assist users in creating data objects that are in compliance with relevant guidelines, which improves over the limited functionality of existing construction management software applications, as described above. The disclosed AI architecture also provides other improvements over the existing construction management software applications, as will be appreciated based on the discussion that follows.

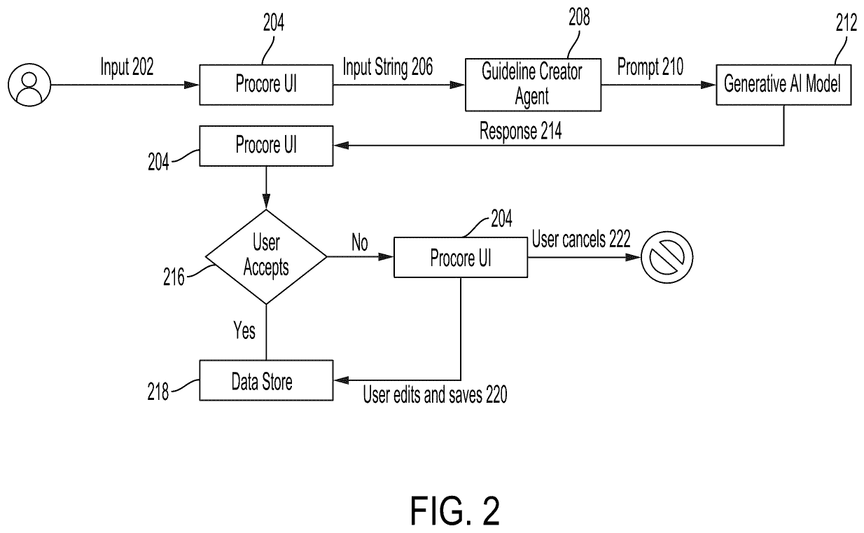

Turning now to FIG. 2, a block diagram 200 is shown that depicts example functionality for implementing the disclosed software-based AI architecture to create a new guideline for evaluating data objects created via the construction management software application. In practice, the functionality of the block diagram 200 may be encoded in the form of program instructions that are executable by one or more processors of a computing platform and one or more processors of a client device, and for purposes of illustration, the functionality of the block diagram 200 is described as being carried out by the back-end computing platform 102 and the client device 104 of FIG. 1, but it should be understood that the functionality of the block diagram 200 may be carried out by any one or more client devices and computing platforms that are capable of being installed with software for performing the functions described below. Further, it should be understood that the functionality of the block diagram 200 is merely described in this manner for the sake of clarity and explanation and that the functionality of the block diagram 200 may be implemented in various other manners, including the possibility that functions may be added, removed, rearranged into different orders, combined into fewer blocks, and/or separated into additional blocks depending upon the particular example.

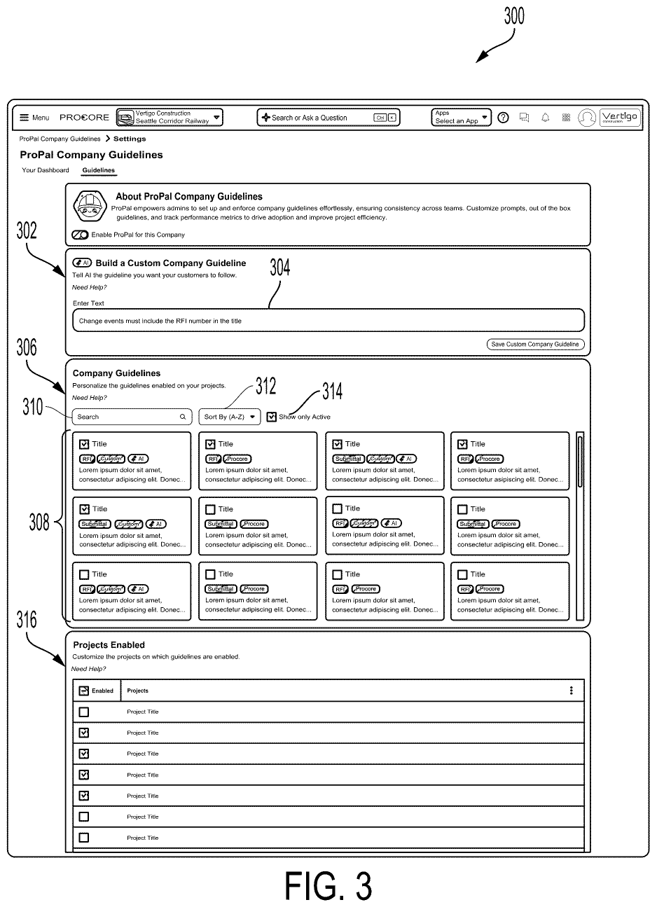

The block diagram 200 may begin with a user of the construction management software application that is tasked with creating new guidelines providing input 202 to the client device 104, e.g., via a user interface 204 that is presented to the user via the client device 104. The user interface 204 that is presented by the client device 104 may take various forms and is described in greater detail below with respect to FIG. 3.

The input 202 may take various forms. As one possibility, the input 202 may take the form of a natural language description of a new guideline to be created, which the user may enter into an input field or the like that is included in the user interface 204. The natural language description could be for any type of guideline that the user may desire to create, including guidelines for any of the types of data objects previously described. Some non-limiting examples of natural language descriptions of new guidelines may include: “verify that submittals have titles that are concise and accurate,” “verify that RFIs have questions with at least 100 characters and that clearly indicate an actual question,” “verify that schedule-items are created with deadlines that are at least 3 days away,” and “verify that RFIs are properly assigned to the correct party,” among numerous other possible examples. The input 202 may take other forms as well.

In some implementations, the natural language description may include more information than what is shown in the examples above. One possible example may include: “Submittal Title Guideline—Verify that submittals have titles that are concise and accurate. You should score the guideline based on if the title accurately represents the content of the submittal and that there does not exist a shorter version of the title that could convey the same information. If the title is not representative of the submittal information or there exists a shorter version of the title that could convert the same information, you should recommend the alternative title.” Various other examples may also exist.

After obtaining the input 202, the client device 104 may encode the natural language description into an input string 206 that is sent to back-end computing platform 102 and ultimately to a guideline creation agent 208. The input string 206 may take the form of one or more messages (e.g., one or more HyperText Transfer Protocol (HTTP) messages) that are sent over the communication path 106 between the client device 104 and the back-end computing platform 102, and, in at least some implementations, the communication may be sent via one or more APIs.

The guideline creation agent 208 may function to generate a prompt 210 based on the input string 206 and pass the prompt 210 to a generative AI model 212 and thereby cause the generative AI model 212 to provide a response comprising a candidate guideline 214.

The prompt 210 generated by the guideline creation agent 208 may take various forms and may include various aspects. One possible aspect of the prompt 210 may include a request to generate a candidate guideline. In line with the previous discussion, the request to generate the candidate guideline may include a request to write a title and a rule for the candidate guideline. As an example, such a request within the prompt 210 may be “Give the candidate guideline a short title and write a sentence or two that lays out the rule that will be used by another generative AI model to score whether a data object meets the rule.” Further, in some implementations, the request to generate the candidate guideline may include additional requests, such as a request to write a scoring criterion for the candidate guideline and/or a request to write a recommendation for the candidate guideline. As an example, such a request within the prompt 210 may be “Write a scoring criterion for determining a score that indicates whether a data object meets the rule and write recommendations for how the user may bring the data object into compliance with the candidate guideline.” The request to generate the candidate guideline may take other forms as well, including a request to generate multiple rules, multiple scoring criteria, and/or multiple recommendations.

Another possible aspect of the prompt 210 may include a request to determine which software tool is related to the candidate guideline, in line with the previous discussion. Yet another possible aspect of the prompt 210 may include an identification of a particular role that the generative AI model 212 should utilize when performing requested tasks. Yet another possible aspect of the prompt 210 may include contextual information that may assist the generative AI model 212 in performing requested tasks, such as a list of the software tools and/or background details, facts, or the like that may be relevant to the requested tasks. Yet another possible aspect of the prompt 210 may include a specification of the output format that is to be utilized by the generative AI model 212 when performing requested tasks, such as a specification of a format that new candidate guidelines should be output in, among other examples. The prompt 210 may include other aspects as well.

The guideline creation agent 208 may generate the prompt 210 in various ways.

As one possibility, the guideline creation agent 208 may coordinate with one or more subagents for generating the prompt 210. There may be various kinds of subagents that the guideline creation agent 208 may coordinate with to generate the prompt 210. In some implementations, there may be one or more subagents that are configured for different software tools. For instance, there may be one or more subagents that are configured for the RFIs tool, one or more subagents that are configured for the Submittals tool, and so on. Further, in some implementations, there may be one or more subagents that are configured for different data elements that are included in data objects. For instance, there may be one or more subagents that are configured for titles, one or more subagents that are configured for deadlines, one or more subagents that are configured for cost estimates, and so forth. Further yet, in some implementations, there may be one or more subagents that are configured for different subjects and/or industries. For instance, there may be one or more subagents that are configured for data objects related to HVAC systems, one or more subagents that are configured for data objects related to plumbing systems, one or more subagents that are configured for data objects related to electrical systems, and so forth. Further yet, in some implementations, there may be one or more subagents that are configured for using different tones, such as different personalities or the like. For instance, there may be one or more subagents that are configured for using professional tones, one or more subagents that are configured for using conversational tones, and so forth. Further yet, in some implementations, there may be one or more subagents that are configured for different aspects of the prompt to be generated, in line with the discussion above. Various other implementations also exist, including the possibility that subagents may be configured for any combination of the examples described above, such as subagents that are configured for a given software tool as well as for a given industry, among other possibilities. The guideline creation agent 208 may coordinate with other kinds of subagents as well.

The subagents may be configured to assist the guideline creation agent 208 in generating the prompt 210 in various ways. As one possibility, subagents may have access to different information, depending on what they are configured for, and subagents may use this information to assist in creating prompts that are more relevant. As some non-limiting examples, this may include software tool-specific information, construction project-specific information, and/or industry-specific information, among numerous other examples. As another possibility, subagents may have access to different generative AI models that have been trained in different ways, which the subagents may utilize to assist the guideline creation agent 208 in generating the prompt 210. Other possibilities may also exist.

The guideline creation agent 208 may determine which subagent(s) to coordinate with to generate the prompt 210 in various ways, such as based on the natural language description indicated in the input string 206. For instance, the guideline creation agent 208 may determine, from the natural language description, which software tool is most likely to be relevant, and may coordinate with one or more subagents that are configured for the determined software tool to generate the prompt 210. As another example, the guideline creation agent 208 may determine, from the natural language description, which data elements included in data objects are most likely to be relevant, and may coordinate with one or more subagents that are configured for the determined data elements. Various other examples may also exist. In practice, the guideline creation agent 208 may utilize a generative AI model to determine which subagent(s) to coordinate with, such as the generative AI model 212 or another generative AI model.

As another possibility, the guideline creation agent 208 may generate the prompt 210 based on a set of rules. For instance, the set of rules may include rules for determining each aspect of the prompt 210, e.g., based on the natural language description indicated in the input string 206. The set of rules may take other forms as well.

The guideline creation agent 208 may generate the prompt 210 in other ways as well.

In some implementations, the prompt 210 may be user-editable, e.g., to correct one or more aspects of the prompt 210 and/or to add additional details to the prompt 210. For instance, the client device 104 may present, via the user interface 204, one or more input fields for editing the prompt 210. The prompt 210 may be user-editable in other ways as well.

In some implementations, the guideline creation agent 208 may include a system prompt that describes the functionality of the guideline creation agent 208, such as how the guideline creation agent 208 is to generate the prompt 210. The system prompt may be provided to the guideline creation agent 208 (e.g., as part of the creation of the guideline creation agent 208), and in at least some implementations, the system prompt may not be editable by users of the guideline creation agent 208. The system prompt may take various forms, and may include things such as (i) description of a role that the guideline creation agent 208 is to take, (ii) a description of how the guideline creation agent 208 is to generate prompts for generative AI models based on input, and/or (ii) a description of what structure the prompts for generative AI models are to take, among various other possibilities. An example of such a system prompt may be “You are an assistant designed to use generative AI models to help users create guidelines from natural language input. Take the input and generate a prompt for a generative AI model to create a new candidate guideline based on the input. In the prompt, include a request to (i) give the new candidate guideline a short title, (ii) select which software tool the new candidate guideline relates to, and (iii) write out a sentence or two that lays out the rule that will be used by another generative AI model to score whether a data object meets that rule, which will score on a pass/fail basis.” The guideline creation agent's system prompt may take other forms as well. Further, the guideline creation agent 208 may be provided with a list of the software tools of the construction management software application, such as those previously described, which the guideline creation agent 208 may include in the prompt 210. The guideline creation agent 208 may be provided with other information as well.

In line with the previous discussion, after generating the prompt 210, the guideline creation agent 208 may provide the prompt 210 to the generative AI model 212 and thereby cause the generative AI model 212 to output a response comprising the candidate guideline 214 based on the prompt 210 that is transmitted to the client device 104.

In line with the previous discussion, the candidate guideline 214 may include various components, including (i) a title, (ii) a rule, (iii) a scoring criterion, and possibly (iv) a recommendation. In an example where the natural language description for the candidate guideline 214 was “create a guideline for RFIs to have Questions with at least 100 characters,” example values for the components of the candidate guideline 214 may include (i) a title “RFI Minimum Word Count,” (ii) a rule “The Question should be at least 100 characters,” (iii) a scoring criterion “Score a 0 if the Question is fewer than 100 characters, and a 1 if the Question is at least 100 characters,” and (iv) a recommendation “Please provide your recommendations in a polite manner. Format the recommendations as a list of items.” As another example where the natural language description for the candidate guideline 214 was “Submittal Title Guideline-Verify that submittals have titles that are concise and accurate. You should score the guideline based on if the title accurately represents the content of the submittal and that there does not exist a shorter version of the title that could convey the same information. If the title is not representative of the submittal information or there exists a shorter version of the title that could convert the same information, you should recommend the alternative title. ,” example values for the components of the candidate guideline 214 may include (i) a title “Submittal Titles,” (ii) a first rule “The submittal title should reflect the underlying content,” (iii) a second rule “The submittal title should be as concise as possible,” (iv) a scoring criterion “Score a 0 if the title does not reflect the underlying content and a 1 if the title does reflect the underlying content,” and (v) a recommendation “If needed, provide an alternative title that is reflective of the underlying content and/or more concise.” Numerous other examples may also exist.

The guideline creation agent's functionality of passing the generated prompt 210 to the generative AI model 212 and the generative AI model's functionality of transmitting the candidate guideline 214 to the client device 104 may take any of various forms, which may depend in part on where the generative AI model 212 is hosted. For instance, in an implementation where the generative AI model 212 is hosted on a separate computing platform from the back-end computing platform 102, these functionalities may involve the guideline creation agent 208 sending the generated prompt 210 to the generative AI model 212 over an external network-based communication path (e.g., via an API or the like), and then the generative AI model 212 transmitting the candidate guideline to the client device 104 over the external network-based communication path. Alternatively, in an implementation where the generative AI model 212 is hosted on the back-end computing platform 102, these functionalities may involve the guideline creation agent 208 sending the prompt 210 to the generative AI model 212 via an internal communication path (e.g., an internal API, a messaging queue or bus, or some other form of inter-process communication), and then the generative AI model 212 transmitting the candidate guideline 214 to the client device 104 over the internal communication path. The functionality of the guideline creation agent 208 passing the prompt 210 to the generative AI model 212 and the functionality of the generative AI model 212 transmitting the candidate guideline 214 to the client device 104 may take other forms as well.

In some implementations, the guideline creation agent 208 may be configured to receive the candidate guideline 214 from the generative AI model 212, rather than the client device 104. In such implementations, the guideline creation agent 208 may, after receiving the candidate guideline 214, transmit a message indicating the candidate guideline 214 to the client device 104, e.g., via the communication path 106. Further, in some implementations, the guideline creation agent 208 may be configured to verify the candidate guideline 214 before transmitting the candidate guideline 214 to the client device 104. For instance, the guideline creation agent 208 may be configured to send one or more follow up prompts to the generative AI model 212 to refine the candidate guideline 214, and/or to perform one or more operations to reformat or otherwise adjust the candidate guideline 214 before transmitting the candidate guideline 214 to the client device 104.

After receiving the candidate guideline 214, the client device 104 may present the candidate guideline 214 to the user, e.g., by updating the user interface 204 to include a visualization of the candidate guideline 214.

At block 216, the client device 104 may determine whether the user accepts or rejects the candidate guideline 214, e.g., based on detecting a selection of an “accept” selectable icon or “reject” selectable icon that may be included in the user interface 204 or the like. After determining that the user accepts the candidate guideline 214, the client device 104 may cause the candidate guideline 214 to be stored within a data store 218 that may be within the data storage layer of the back-end computing platform 102 or otherwise accessible to the back-end computing platform 102. For instance, the client device 104 may transmit an indication of the user's acceptance of the candidate guideline 214 to the back-end computing platform 102, and the back-end computing platform 102 may, based on receiving the indication from the client device 104, store the candidate guideline 214 within the data store 218.

If the client device 104 determines that the user rejects the candidate guideline 214, then the client device 104 may determine a user response to the candidate guideline 214, which may take various forms. As one possibility, the client device 104 may determine a user response 220 to the candidate guideline 214 indicating one or more edits to the candidate guideline 214. Based on detecting the user response 220, the client device 104 may cause the candidate guideline 214 as-edited to be stored within the data store 218, e.g., in the manner described above. The user response 220 may take various forms. As one example, the user response 220 may include edits to one or more of the components of the candidate guideline 214, such as revisions to a title of the candidate guideline 214 or to a rule of the candidate guideline 214. As another example, the user response 220 may include edits to add a component to the candidate guideline 214 that was not included before, such as a scoring criterion and/or a recommendation, e.g., in implementations where the candidate guideline 214 did not already include such a scoring criterion and/or recommendation. Various other examples may also exist.

As another possibility, the client device 104 may determine a user response 222 to the candidate guideline 214 indicating a request to cancel the candidate guideline 214. For instance, the client device 104 may detect a user selection of a “cancel” selectable icon or the like that may be included in the user interface 204. Based on determining the user response 222, the client device may determine not to cause the candidate guideline 214 to be stored within the data store 218.

It should be understood that the example functionality shown in the block diagram 200 is just one example of how the disclosed software-based AI architecture may be used to create new guidelines. In practice, the disclosed software-based AI architecture may be used to create new guidelines in other ways as well. As one possibility, the disclosed software-based AI architecture may include functionality for allowing users of the construction management software application to create new guidelines by importing guidelines into the construction management software application and/or by selecting predefined guideline templates presented within a user interface of the construction management software application, among other possibilities. As another possibility, the disclosed software-based AI architecture may include functionality for allowing users of the construction management software application to enable guidelines for select projects within the construction management software application guidelines. Various other possibilities may also exist.

FIG. 3 depicts an example 300 of a user interface that may be presented to a user of the construction management software application for creating new guidelines via a client device, such as the client device 104. As shown, the example user interface 300 includes a first view 302 for defining a new guideline. The first view includes an input field 304, where the user may provide a natural language description of a guideline to be created, in line with the previous discussion. In some implementations, the first view 302 may include additional features, such as options to import guidelines, among other examples.

The example user interface 300 also includes a second view 306 for selecting predefined guideline templates, which the user may select to be applied to new data objects as they are being created within the construction management software application. As shown, the second view 306 includes a set of predefined guideline templates 308, which may have been created by the provider of the construction management software application, by the user, or by some other user (e.g., by another user within the same party as the user, by a third party, etc.). The second view 306 also includes a number of tools for searching the set of predefined guideline templates 308, including an input field 310, a picklist 312, and a “show only active” toggle button 314. By inputting search criteria into the input field 310, the user may cause the set of predefined guideline templates 308 to update to include predefined guideline templates that match the input search criteria. Further, by selecting an option presented within the picklist 312, the user may cause the set of predefined guideline templates 308 to become sorted according to the selected option presented within the picklist 312 (e.g., by most popular, by most recent, alphabetically, by software tool, etc.). Further yet, by enabling the “show only active” toggle button 314, the user may cause the set of predefined guideline templates 308 to update to only include predefined guideline templates that are active, which may refer to predefined guideline templates that are set be applied to data objects as they are being created within the construction management software application. The second view 306 may include other features as well.

The example user interface 300 also includes a third view 316 for linking the new guideline (or one or more predefined guideline templates) to one or more construction projects within the construction management software application, such that the linked guideline(s) will be applied to new data objects as they are being created for the one or more construction projects within the construction management software application.

Although not shown, the example user interface 300 may include other features as well, such as a feature for editing predefined guideline templates, among other examples. Further, the example user interface 300 may also be updated to present candidate guidelines that are generated based on the input provided via the input field 304, as well as selectable icons, input fields, and the like for approving, editing, or canceling candidate guidelines, in line with the discussion above with respect to FIG. 2. Various other possibilities may also exist.

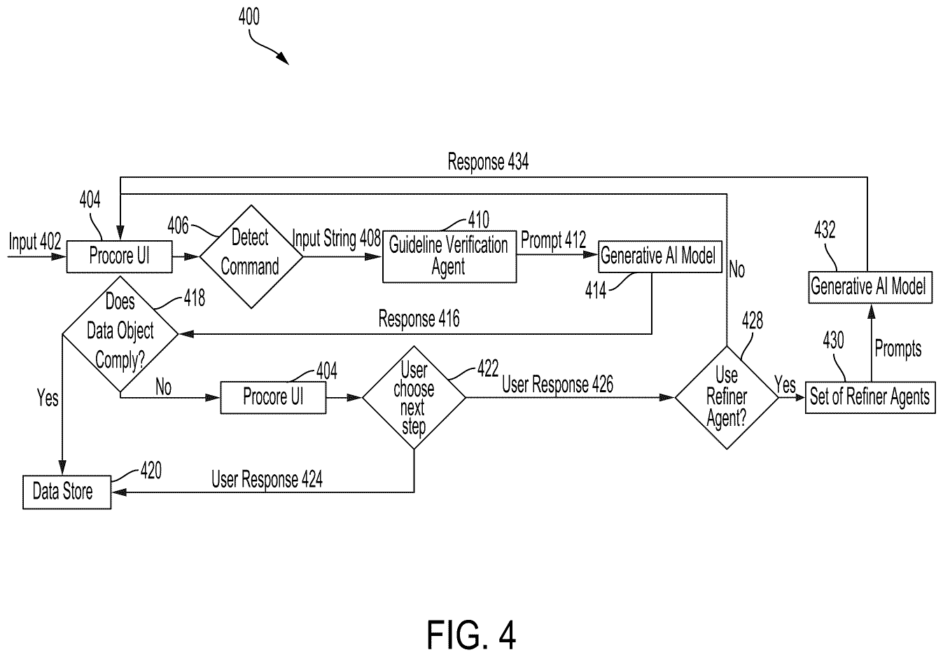

Turning now to FIG. 4, a block diagram 400 is shown that depicts example functionality for implementing the disclosed software-based AI architecture to verify and refine new data objects that are being created within the construction management software application. In practice, the functionality of the block diagram 200 may be encoded in the form of program instructions that are executable by one or more processors of computing platform and one or more processors of a client device, and for purposes of illustration, the functionality of the block diagram 400 is described as being carried out by the back-end computing platform 102 and the client device 104 of FIG. 1, but it should be understood that the functionality of the block diagram 400 may be carried out by any one or more client devices and computing platforms that are capable of being installed with software for performing the functions described below. Further, it should be understood that the functionality of the block diagram 400 is merely described in this manner for the sake of clarity and explanation and that the functionality of the block diagram 400 may be implemented in various other manners, including the possibility that functions may be added, removed, rearranged into different orders, combined into fewer blocks, and/or separated into additional blocks depending upon the particular example.

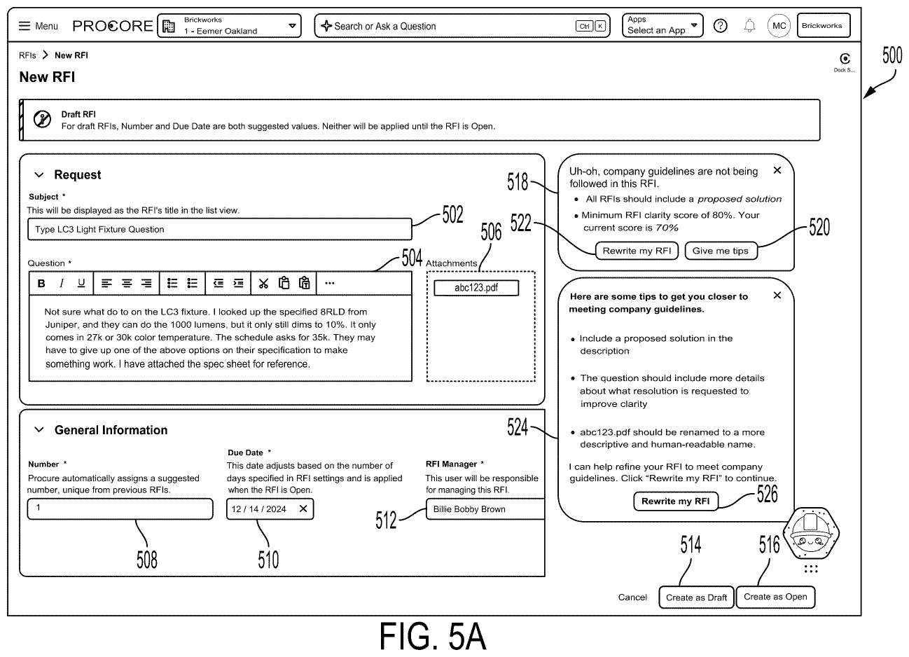

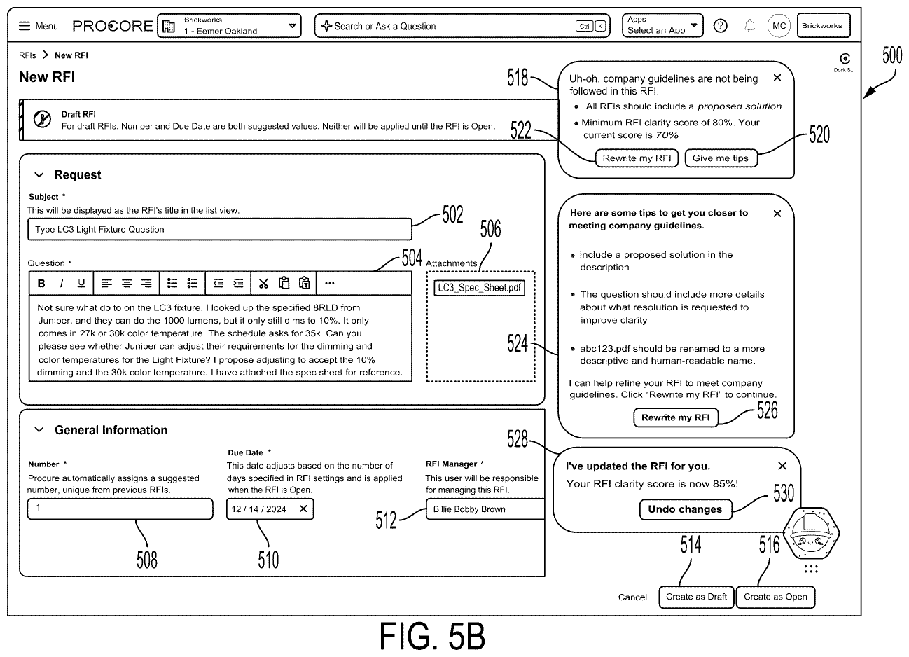

The block diagram 400 may begin with a user of the construction management software application that is tasked with creating data objects providing input 402 to the client device 104, e.g., via a user interface 404 that is presented to the user via the client device 104. The user interface 404 that is presented by the client device 104 may take various forms, and is described in greater detail below with respect to FIGS. 5A-5B.

The input 402 may include values for a set of data elements of a new data object that is to be created. The set of data elements may take various forms, e.g., depending on which type of data object is being created. For instance, if the new data object is an RFI data object, then the input 402 may include values for one or more of the data elements that may be included in RFI data objects. Other examples may also exist.

At block 406, the client device 104 may detect an indication of a command to create the new data object indicated in the input 402, e.g., based on the user selecting a “create” selectable icon or the like that may be presented within the user interface 404.

After detecting the indication of the command to create the new data object, the client device 104 may encode the values for the set of data elements included in the input 402 into an input string 408 that is sent to back-end computing platform 102 and ultimately to a guideline verification agent 410. The input string 408 may take the form of one or more messages (e.g., one or more HyperText Transfer Protocol (HTTP) messages) that are sent over the communication path 106 between the client device 104 and the back-end computing platform 102.

The guideline verification agent 410 may function to generate a prompt 412 based on the input string 408 and pass the prompt 412 to a generative AI model 414 and thereby cause the generative AI model 414 to provide a response 416 comprising, among other things, an indication of whether the new data object complies with a set of guidelines corresponding to the new data object.

The prompt 412 generated by the guideline verification agent 410 may take various forms and may include various aspects. One possible aspect of the prompt 412 may include an indication of a set of guidelines that is to be applied to the new data object. Another possible aspect of the prompt 412 may include an indication of the new data object. For instance, the prompt 412 may include indications of some or all of the data element values that are indicated in the input string 408. Yet another possible aspect of the prompt 412 may include instructions for how to apply the set of guidelines to the new data object. For instance, the prompt 412 may include instructions to apply the set of guidelines on a data element by data element basis, among other examples. Yet another possible aspect of the prompt 412 may include an identification of a particular role that the generative AI model 414 should utilize when performing requested tasks. Yet another possible aspect of the prompt 412 may include contextual information that may assist the generative AI model 414 in performing requested tasks, such as a list of the software tools and/or background details, facts, or the like that may be relevant to the requested tasks. Yet another possible aspect of the prompt 412 may include a specification of the output format that is to be utilized by the generative AI model 414 when performing requested tasks, such as a specification of a format that the response 416 should be output in, among other examples. The prompt 412 may include other aspects as well.

To determine the set of guidelines that are to be applied to the new data object to be created, the guideline verification agent 410 may (i) determine which software tool is being used to create the new data object, e.g., which may be indicated in the input string 408, (ii) identify the guidelines that have been created for the determined software tool, e.g., from the data store 218 previously described or elsewhere, and then (iii) determine, from the identified guidelines, which guidelines are to be included in the set of guidelines that are to be applied to the new data object.

The guideline verification agent 410 may determine, from the identified guidelines, which guidelines are to be included in the set of guidelines that are to be applied to the new data object in various ways.

As one possibility, the guideline verification agent 410 may coordinate with one or more subagents to determine the set of guidelines from the identified guidelines. There may be various kinds of subagents that the guideline verification agent 410 may coordinate with to determine the set of guidelines. In some implementations, there may be one or more subagents that are configured for different software tools. For instance, there may be one or more subagents that are configured for the RFIs tool, one or more subagents that are configured for the Submittals tool, and so on. Further, in some implementations, there may be one or more subagents that are configured for different data elements that are included in data objects. For instance, there may be one or more subagents that are configured for titles, one or more subagents that are configured for deadlines, one or more subagents that are configured for cost estimates, and so forth. Further yet, in some implementations, there may be one or more subagents that are configured for different subjects and/or industries. For instance, there may be one or more subagents that are configured for HVAC systems, one or more subagents that are configured for plumbing systems, one or more subagents that are configured for electrical systems, and so forth. Various other implementations also exist, including the possibility that subagents may be configured for any combination of the examples described above, such as subagents that are configured for a given software tool as well as for a given industry, among other possibilities. The guideline verification agent 410 may coordinate with other kinds of subagents as well.

The subagents may be configured to assist the guideline verification agent 410 in determining the set of guidelines in various ways. As one possibility, subagents may have access to different information, depending on what they are configured for, and subagents may use this information to assist in determining the set of guidelines. As some non-limiting examples, this may include software tool-specific information, construction project-specific information, and/or industry-specific information, among numerous other examples. As another possibility, subagents may have access to different generative AI models that have been trained in different ways, which the subagents may utilize to assist the guideline verification agent 410 in determining the set of guidelines. Other possibilities may also exist. In some implementations, each subagents may include a respective system prompt that describes the functionality of the subagent. Other implementations are also possible.

The guideline verification agent 410 may determine which subagent(s) to coordinate with to determine the set of guidelines in various ways. For instance, after determining which software tool is being used to create the new data object, the guideline verification agent 410 may coordinate with one or more subagents that are configured for the determined software tool to determine the set of guidelines. As another example, the guideline verification agent 410 may determine, from the input string 408, which type of data object is being created, and may coordinate with one or more subagents that are configured for data elements of the determined type of data object. This may include data elements with values that are indicated in the input string 408, and in some implementations may also include data elements without any values being indicated in the input string 408. Various other examples may also exist. In practice, the guideline creation agent 208 may utilize a generative AI model to determine which subagent(s) to coordinate with, such as the generative AI model 414 or another generative AI model.

As another possibility, the guideline verification agent 410 may determine the set of guidelines from the identified guidelines based on a set of rules. For instance, the set of rules may include rules for determining which guidelines are most likely to be relevant to the new data object, e.g., based on which software tool is being used to create the new data object and/or based on what types of data elements are included in the new data object. The set of rules may take other forms as well.

The guideline verification agent 410 may determine the set of guidelines in other ways as well.

After determining the set of guidelines, the guideline verification agent 410 may generate the prompt 412, which the guideline verification agent 410 may accomplish in various ways. As one possibility, the guideline verification agent 410 may coordinate with one or more subagents for generating the prompt 412. These subagents may be the same or similar to those described above, with the exception that instead of being configured to assist the guideline verification agent 410 in determining the set of guidelines, these subagents may instead be configured to assist the guideline verification agent 410 in generating the prompt 412. For instance, the subagents for generating the prompt 412 may each include a respective system prompt that describes the functionality of the subagent.

The guideline verification agent 410 may determine which subagent(s) to coordinate with to generate the prompt 412 in various ways, such as based on the input string 408. In practice, this functionality may be similar to the functionality described above for determining which subagent(s) to coordinate with to determine the set of guidelines.

As another possibility, the guideline verification agent 410 may generate the prompt 412 based on a set of rules. For instance, the set of rules may include rules for determining each aspect of the prompt 412, e.g., based on the information indicated in the input string 408. The set of rules may take other forms as well.

The guideline verification agent 410 may generate the prompt 412 in other ways as well.

In some implementations, the prompt 412 may be user-editable, e.g., to correct one or more aspects of the prompt 412 and/or to add additional details to the prompt 412. For instance, the client device 104 may present, via the user interface 404, one or more input fields for editing the prompt 412. The prompt 412 may be user-editable in other ways as well.

In line with the previous discussion, after generating the prompt 412, the guideline verification agent 410 may provide the prompt 412 to the generative AI model 414 and thereby cause the generative AI model 414 to output a response 416 based on the prompt 412 that may be transmitted to the client device 104.

The response 416 may take various forms and may include various aspects. One possible aspect of the response 416 may include an indication of whether the new data object complies with all of the guidelines of the set of guidelines. For instance, if the new data object complies with all of the guidelines of the set of guidelines, then the response 416 may include an indication that the new data object complies with all relevant guidelines. On the other hand, if the new data object does not comply with all of the guidelines of the set of guidelines, then the response 416 may include an indication that one or more guidelines of the set of guidelines have not been met.

Another possible aspect of the response 416 may include a respective indication of one or more of the guidelines of the set of guidelines. In some implementations, this may include a respective indication of each guideline of the set of guidelines that the new data object is not in compliance with, while in other implementations, this may include a respective indication for each guideline of the set of guidelines, including those that are being complied with. Other examples may also exist.

Yet another possible aspect of the response 416 may include a respective score for one or more guidelines of the set of guidelines. In some implementations, this may include a respective score for each guideline of the set of guidelines, while in other implementations, this may include a respective score for only some of the set of guidelines, such as for guidelines that the new data object is not in compliance with. For instance, in line with the discussion above, the generative AI model 414 may determine the scores based on the respective scoring criteria included in the set of guidelines, among other things.

Yet another possible aspect of the response 416 may include a respective indication of one or more recommendations for bringing the new data object into compliance with the set of guidelines. For instance, in line with the discussion above, the generative AI model 414 may determine the one or more recommendations based on respective recommendations included in the set of guidelines, among other things.

The response 416 may take other forms as well.

The guideline verification agent's functionality of passing the generated prompt 412 to the generative AI model 414 and the generative AI model's functionality of transmitting the response 416 to the client device 104 may take any of various forms, which may depend in part on where the generative AI model 414 is hosted. For instance, in an implementation where the generative AI model 414 is hosted on a separate computing platform from the back-end computing platform 102, these functionalities may involve the guideline verification agent 410 sending the generated prompt 412 to the generative AI model 414 over an external network-based communication path (e.g., via an API or the like), and then the generative AI model 414 transmitting the response 416 to the client device 104 over the external network-based communication path. Alternatively, in an implementation where the generative AI model 414 is hosted on the back-end computing platform 102, these functionalities may involve the guideline verification agent 410 sending the prompt 412 to the generative AI model 414 via an internal communication path (e.g., an internal API, a messaging queue or bus, or some other form of inter-process communication), and then the generative AI model 414 transmitting the response 416 to the client device 104 over the internal communication path. The functionality of the guideline verification agent 410 passing the prompt 412 to the generative AI model 414 and the functionality of the generative AI model 414 transmitting the response 416 to the client device 104 may take other forms as well.

In some implementations, the guideline verification agent 410 may be configured to receive the response 416 from the generative AI model 414, rather than the client device 104. In such implementations, the guideline verification agent 410 may, after receiving the response 416, transmit a message indicating the response 416 to the client device 104, e.g., via the communication path 106. Further, in some implementations, the guideline verification agent 410 may be configured to verify the response 416 before transmitting the response 416 to the client device 104. For instance, the guideline verification agent 410 may verify the response 416 by sending one or more follow up prompts to the generative AI model 414 to refine the response 416. Further yet, in some implementations, the guideline verification agent 410 may perform one or more operations to adjust the response 416 before transmitting the response 416 to the client device 104, such as by reformatting one or more aspects of the response 416. In some implementations, the guideline verification agent 410 may coordinate with one or more subagents to verify and/or adjust the response 416. These subagents may be the same or similar to those described above, and may be configured to assist the guideline verification agent 410 in verifying and/or adjusting the response 416. For instance, the subagents for verifying and/or adjusting the response 416 may each include a respective system prompt that describes the functionality of the subagent. The guideline verification agent 410 may verify and/or adjust the response 416 in various other ways before transmitting the response 416 to the client device 104.

After receiving the response 416, the client device 104 may present the response 416 to the user, e.g., by updating the user interface 404 to include a visualization of the response 416. In some implementations, the client device 104 may present certain aspects of the response 416 at various times. For instance, if the response 416 indicates that the new data object is in compliance with each guideline in the set of guidelines, then the client device 104 may (i) present such an indication, and (ii) cause the new data object to be stored within a data store 420 that may be within the data storage layer of the back-end computing platform 102 or otherwise accessible to the back-end computing platform 102. In some implementations, the data store 420 may the same as or similar to the data store 218 describe above with respect to FIG. 2, while in other implementations the data store 420 may be different from the data store 218.

In practice, the client device 104 may cause the new data object to be stored within the data store 420 either automatically or in response to detecting a user indication to do so, which may come in the form of a user selection of a “create” selectable icon or the like that may be presented on the user interface 404. Optionally, in implementations where the new data object is to be stored within the data store 420 automatically, the functionality of storing the new data object within the data store 420 may be performed by the back-end computing platform 102, and the client device 104 may not need to cause the new data object to be stored. Instead, the client device 104 may present the indication that the new data object is in compliance with each guideline in the set of guidelines, as well as possibly an indication that the new data object has been stored within the data store 420, among other examples.

In implementations where the new data object is not in compliance with at least one guideline in the set of guidelines, then the client device 104 may present other aspects of the response 416, such as a respective indication of one or more of the guidelines of the set of guidelines (e.g., for guidelines that are not being complied with), a respective score for one or more guidelines of the set of guidelines (e.g., for guidelines that are not being complied with), and/or a respective indication, for one or more guidelines, of one or more recommendations for bringing the new data object into compliance with the set of guidelines (e.g., for guidelines that are not being complied with), among other possibilities. In some implementations, the client device 104 may present the various aspects to the user at various times, e.g., based on user input. For instance, the user may select a “show recommendations” selectable icon or the like that may be presented on the user interface 404, and based on detecting the user's selection, the client device 104 may begin to present the one or more recommendations to the user. The client device 104 may present the response 416 in various other ways.

Block 418 depicts functionality for determining whether the new data object complies with the set of guidelines. In line with the discussion above, this functionality may be performed by different components and possibly at different times. For instance, as one possibility, the guideline verification agent 410 may perform the functionality of block 418 and, after determining whether the new data object complies with the set of guidelines, the guideline verification agent 410 may (i) cause the new data object to be stored within the data store 420 if it complies with the set of guidelines and/or (ii) transmit the response 416 to the client device 104, so that the client device 104 can present one or more aspects of the response 416 as previously discussed. As another possibility, the client device 104 may perform the functionality of block 418, and may (i) cause the new data object to be stored within the data store 420 if it complies with the set of guidelines and/or (ii) present one or more aspects of the response 416, in line with the previous discussion. As yet another possibility, the back-end computing platform 102 may perform the functionality of block 418. Other possibilities may also exist.

At block 422, the client device 104 may detect a user response to the response 416, which may take various forms. As one possibility, the client device 104 may detect a user response 424 to the response 416 indicating a request to store the new data object as-is within the data store 420, without correcting the new data object based on the response 416. As another possibility, the client device 104 may detect a user response 426 to the response 416 indicating a request to correct the data object to become compliant with the set of guidelines. Although not shown in FIG. 4, other possibilities may also exist, including the possibility that the client device 104 may detect a user response to the response 416 indicating a request to cancel the new data object.

After detecting a user response to the response 416, the client device 104 may perform one or more actions, which may depend on which type of user response the client device 104 detects. As one possibility, based on detecting the user response 424 indicating a request to store the new data object as-is within the data store 420, the client device 104 may cause the new data object to be stored as-is within the data store 420. As another possibility, based on detecting the user response 426 indicating a request to correct the data object to become compliant with the set of guidelines, the client device 104 may determine how the data object is to be corrected, e.g., either based on user edits or by using one or more refiner agents. Further details of this functionality is described below, e.g., with respect to block 428. As yet another possibility, based on detecting a user response indicating a request to cancel the new data object, the client device 104 may cause the new data object to be cancelled. Other possibilities may also exist.

As mentioned above, at block 428, the client device 104 may determine how the new data object is to be corrected. The client device 104 may make this determination in various ways.

As one possibility, the client device 104 may determine that the new data object is to be corrected based on user edits, such as based on detecting user edits to one or more of the data element values included in the input 402 previously described. Other examples may also exist.

As another possibility, the client device 104 may determine that the new data object is to be corrected using one or more refiner agents. For instance, the client device 104 may determine that the new data object is to be corrected using one or more refiner agents based on detecting a selection of a “rewrite” selectable icon or the like that may be presented on the user interface 404. Other examples may also exist.

The client device 104 may determine how the new data object is to be corrected in other ways as well.

If the client device 104 determines that the new data object is to be corrected based on user edits, the example functionality 400 may return to the beginning, with the client device 104 receiving further input 402 including the user edits to the new data object.

If the client device 104 determines that the new data object is to be corrected using one or more refiner agents, then the client device 104 may cause one or more refiner agents to correct the new data object. To accomplish this, the client device 104 may generate and transmit a message to the back-end computing platform 102 indicating a request to cause one or more refiner agents to correct the new data object, for instance, via the communication path 106.

After receiving the message from the client device 104, the back-end computing platform 102 may then determine a set of one or more refiner agents 430 that are to correct the new data object.

There may be various different kinds of refiner agents that the back-end computing platform 102 may select from to determine the set of refiner agents 430. In some implementations, there may be one or more refiner agents that are configured for different software tools. For instance, there may be one or more refiner agents that are configured for the RFIs tool, one or more refiner agents that are configured for the Submittals tool, and so on. Further, in some implementations, there may be one or more refiner agents that are configured for different data elements that are included in data objects. For instance, there may be one or more refiner agents that are configured for titles, one or more refiner agents that are configured for deadlines, one or more refiner agents that are configured for cost estimates, and so forth. Further yet, in some implementations, there may be one or more refiner agents that are configured for different subjects and/or industries. For instance, there may be one or more refiner agents that are configured for HVAC systems, one or more refiner agents that are configured for plumbing systems, one or more refiner agents that are configured for electrical systems, and so forth. Further yet, in some implementations, there may be one or more refiner agents that are configured for different tones, such as different personalities or the like. For instance, there may be one or more refiner agents that are configured for professional tones, one or more refiner agents that are configured for conversational tones, and so forth. Various other implementations also exist, including the possibility that refiner agents may be configured for any combination of the examples described above, such as refiner agents that are configured for a given software tool as well as for a given industry, among other possibilities. The back-end computing platform 102 may select the set of refiner agents 430 from other kinds of refiner agents as well.

The refiner agents may be configured to correct the new data object in various ways. As one possibility, refiner agents may have access to different information, depending on what they are configured for, and refiner agents may use this information in correcting the new data object. As some non-limiting examples, this may include software tool-specific information, construction project-specific information, industry-specific information, among numerous other examples. As another possibility, refiner agents may have access to different generative AI models that have been trained in different ways, which the refiner agents may utilize to correct the new data object. Some examples of such generative AI models may include generative AI models that have been trained to rewrite descriptions in a certain tone, generative AI models that have been trained to identify which members of a construction project are responsible for reviewing certain types of data objects, generative AI models that have been trained to determine resolutions to schedule conflicts, etc. Other possibilities may also exist. In some implementations, each refiner agent may include a respective system prompt that describes the functionality of the refiner agent. Other implementations are also possible.

The back-end computing platform 102 may determine which refiner agents to include in the set of refiner agents 430 in various ways. As one possibility, the back-end computing platform 102 may determine which refiner agents to include in the set of refiner agents 430 based on an indication of a user selection of one or more refiner agents, e.g., via the user interface 404 of the client device 104. As another possibility, the back-end computing platform 102 may determine which refiner agents to include in the set of refiner agents 430 based on an evaluation of the new data object. For instance, the back-end computing platform 102 may determine to include refiner agents that are configured for the data elements included in the new data object. In some implementations, the back-end computing platform 102 may perform this evaluation itself, e.g., based on a set of rules. Additionally or alternatively, the back-end computing platform 102 may utilize a generative AI model or the like to perform the evaluation. Other examples may also exist. As yet another possibility, the back-end computing platform 102 may determine which refiner agents to include in the set of refiner agents 430 based on an evaluation of the software tool being used to create the new data object. For instance, the back-end computing platform 102 may determine to include refiner agents that are configured for the software tool being used to create the new data object. In some implementations, the back-end computing platform 102 may perform this evaluation itself, e.g., based on a set of rules. Additionally or alternatively, the back-end computing platform 102 may utilize a generative AI model or the like to perform the evaluation. Other examples may also exist. As yet another possibility, the back-end computing platform 102 may determine which refiner agents to include in the set of refiner agents 430 based on an evaluation of the set of guidelines. For instance, if the set of guidelines requires that descriptions within the new data object are written in a polite manner, then the back-end computing platform 102 may determine to include refiner agents that are configured for polite tones. In some implementations, the back-end computing platform 102 may perform this evaluation itself, e.g., based on a set of rules. Additionally or alternatively, the back-end computing platform 102 may utilize a generative AI model or the like to perform the evaluation. Other examples may also exist.

The back-end computing platform 102 may determine which refiner agents to include in the set of refiner agents 430 in other ways as well.

After determining the set of refiner agents 430, the back-end computing platform 102 may then cause the set of refiner agents 430 to correct the new data object. To accomplish this, the back-end computing platform 102 may provide the set of refiner agents 430 with (i) the new data object, (ii) whichever guidelines the new data object is not in compliance with, and possibly (iii) instructions to correct the new data object. In some implementations, the back-end computing platform 102 may transmit a respective instruction to each refiner agent of the set of refiner agents 430 that indicates what data element value(s) of the new data object the refiner agent is to correct, while in other implementations, each refiner agent of the set of refiner agents 430 may determine which data element value(s) of the new data object to correct, e.g., based on what the refiner agent is configured for. The back-end computing platform 102 may cause the set of refiner agents 430 to correct the new data object in other ways as well.

The functionality of the set of refiner agents 430 for correcting the new data object may take various forms. As one possibility, the functionality of the set of refiner agents 430 may include providing prompts to a generative AI model 432 to cause the generative AI model 432 to output a response 434 that includes corrections to the new data object. Other implementations are also possible, such as the possibility that the functionality of the set of refiner agents 430 may involve executing respective sets of rules to correct the new data object. In line with the discussion above, the functionality of each refiner agent in the set of refiner agents 430 may be described in a respective system prompt for the refiner agent. Other possibilities may also exist. Further, although the discussion below may refer to corrections to the new data object as being included in the response 434 as output by the generative AI model 432, it should be understood that the corrections to the new data object may be generated by the set of refiner agents 430 in another way.

The prompts provided to the generative AI model 432 may take various forms, and may include (i) data element values of the new data object that are not compliant with the set of guidelines, (ii) guidelines from the set of guidelines that the new data object is not in compliance with, and (iii) instructions to correct the data element values of the new data object that are not compliant with the set of guidelines based on the provided guidelines. The prompts may include other types of information as well, e.g., which may depend on which refiner agent is providing the prompt. For instance, the refiner agents may include relevant information that is accessible to them, e.g., based on their configuration, within prompts to the generative AI model 432 in order to improve the output of the generative AI model 432. Other examples may also exist.

In some implementations, each refiner agent of the set of refiner agents 430 may utilize the same generative AI model 432 to correct one or more data element values of the new data object. Additionally or alternatively, in some implementations, different refiner agents may utilize different generative AI models to correct one or more data element values of the new data object. For instance, in line with the previous discussion, some refiner agents may have access to respective generative AI models that have been trained in different ways, e.g., corresponding to what the refiner agents are configured for, such as generative AI models that have been trained to rewrite descriptions in a certain tone, generative AI models that have been trained to identify which members of a construction project are responsible for reviewing certain types of data objects, generative AI models that have been trained to determine resolutions to schedule conflicts, etc. By using these trained generative AI models, the set of refiner agents 430 may be able to correct the new data object in a more precise manner. In light of this, while the discussion below may refer to the response 434 as being output by the generative AI model 432, it should be understood that the response 434 may include a set of responses, each of which may be output by a respective generative AI model utilized by one or more of the set of refiner agents 430.

The corrections included in the response 434 may take various forms, and some non-limiting examples may include rewritten descriptions, renamed attachments, revised deadlines, different assignees for reviewing the new data object, etc., which may depend on whichever data element values of the new data object were not compliant with the set of guidelines. The corrections included in the response 434 may take other forms as well.

The response 434 may be used to refine the input 402. For instance, data element values of the input 402 that did not comply with the set of guidelines may be replaced with the corresponding corrections included in the response 434. The revisions to the input 402 may be presented to the user via the user interface 404, after which the functionality of the block diagram 400 may continue as before, with the client device 104 detecting, at block 406, an indication of a command to create the corrected data object.

FIG. 5A depicts an example 500 of a user interface that may be presented, via a client device such as the client device 104, to a user of the construction management software application for creating and verifying a new RFI data object. As shown, the example user interface 500 includes several input fields for entering values for data elements of the new RFI data object, including (i) a first input field 502, which may be populated with a value for a “Subject” data element of the new RFI data object, (ii) a second input field 504, which may be populated with a value for a “Question” data element of the new RFI data object, (iii) a third input field 506, which may be populated with a value for an “Attachments” data element of the new RFI data object, (iv) a fourth input field 508, which may be populated with a value for a “Number” data element of the new RFI data object, (v) a fifth input field 510, which may be populated with a value for a “Due Date” data element of the new RFI data object, and (vi) a sixth input field 512, which may be populated with a value for an “RFI Manager” data element of the new RFI data object.

As shown, the first input field 502 has been populated with a value taking the form of the description: “Type LC3 Light Fixture Question.” Further, as shown, the second input field 504 has been populated with a value taking the form of the description: “Not sure what to do on the LC3 fixture. I looked up the specified BRLD from Juniper, and they can do the 1000 lumens, but it only still dims to 10%. It only comes in 27 k or 30 k color temperature. The schedule asks for 35 k. They may have to give up one of the above options on their specification to make something work. I have attached the spec sheet for reference.” Further yet, as shown, the third input field 506 has been populated with a value taking the form of an attachment named “abc123.pdf.” Further yet, as shown, the fourth input field 508 has been populated with a value taking the form of the number “1.” Further yet, as shown, the fifth input field 510 has been populated with a value taking the form of the date “12/14/2024.” Further yet, as shown, the sixth input field 512 has been populated with a value taking the form of an identifier “Billie Bobby Brown,” which may correspond to an account of an RFI manager.

The values for the input fields 502-512 may be populated in various ways, such as by being entered by the user and/or by being automatically populated by the construction management software application.

After the values for the input fields 502-512 have been populated, the user may select a “Create as Draft” selectable icon 514 or a “Create as Open” selectable icon 516. The client device 104 may then detect the user's selection of the selectable icon 514 or the selectable icon 516. The values for the input fields 502-512 may be one example of the input 402 described above with respect to FIG. 4, and the client device's detection of the user selection of the selectable icon 514 or the selectable icon 516 may be one example of operations of block 406 as described above with respect to FIG. 4. After the client device 104 detects the user selection of the selectable icon 514 or the selectable icon 516, operations of the block diagram 400 may continue as discussed above until the client device 104 receives and presents at least some aspects of the response 416. In the example user interface 500, these aspects are shown in a notification 518 indicating that (i) the new RFI data object being created does not comply with one or more guidelines, (ii) RFI data objects should include a proposed solution, and (iii) RFI data objects should have a clarity score of 80%, while the new RFI data object being created has a current clarity score of 50%.

The notification 518 also includes (i) a selectable icon 520 for presenting recommendations for bringing the new RFI data object into compliance with the set of guidelines and (ii) a selectable icon 522 for causing one or more refiner agents to rewrite the new RFI data object to bring it into compliance with the set of guidelines.

If the client device 104 detect user edits to the new RFI data object (e.g., which the user may provide based on the information included in the notification 518), then the example functionality 400 of FIG. 4 may return to the beginning, with the client device 104 receiving further user input 402 including the user edits the new RFI data object.

If the client device 104 detects a user selection of the selectable icon 520, then the client device 104 may present additional aspects of the response 416—such as the one or more recommendations included in the response 416. In the example user interface 500, this is shown in a notification 524 indicating various recommendations for bringing the new RFI data object being created into compliance with the set of guidelines. Further, as shown, the notification 524 also includes a selectable icon 526 for causing one or more refiner agents to rewrite the new RFI data object being created to bring it into compliance with the set of guidelines.

If the client device 104 detect user edits to the new RFI data object (e.g., which the user may provide based on the recommendations included in the notification 524), then the example functionality 400 of FIG. 4 may return to the beginning, with the client device 104 receiving further user input 402 including the user edits the new RFI data object.

If the user If the client device 104 detects a user selection of the selectable icon 522 or the selectable icon 526, then the client device 104 may cause one or more refiner agents to correct the new data object, in line with the discussion above.

FIG. 5B shows how the RFI data object shown in FIG. 5A may be refined using one or more refiner agents in line with the discussion above. As shown, values for several of the input fields 502-512 that did not comply with the set of guidelines have been corrected, and a new notification 528 is presented, indicating that the RFI data object being created now has a clarity score of 85% and is in compliance with the set of guidelines. Further, as shown, the notification 528 also includes an “undo changes” selectable icon 530 for undoing the changes that were made to the new data object. If the client device 104 detects a selection of the selectable icon 530, the client device 104 may then cause the values for the input fields 502-512 to be reverted to their previous state before being rewritten.

It should be understood that while FIGS. 5A-5B depict an example user interface for creating, verifying, and refining RFI data objects, e.g., within an RFIs software tool, in practice, user interfaces presented via the client device 104 may include options for creating, verifying, and refining other types of data objects, e.g., within other software tools, as previously described. Further, in practice, user interfaces presented to the user for creating, verifying, and refining new data objects may include input fields for more or fewer of the data elements shown in the example user interface 500.

In addition to the functionality described for creating, validating, and rewriting data objects, the disclosed software-based AI architecture may also be used to perform additional functionality. As one possibility, the disclosed software-based AI architecture may provide workflows or other options for allowing users to create and/or edit one or more subagents and/or one or more refiner agents (e.g., by creating and/or editing system prompts for subagents and/or refiner agents). These subagents and/or refiner agents be available for use by the user for their own projects or possibly for other users as well.

As another possibility, the disclosed software-based AI architecture may be used to generate and present statistics or other metrics. These statistics may take various forms, such as (i) user-level statistics showing performance ratings against one or more guidelines and/or (ii) guideline-level statistics showing things such as indications of user satisfaction levels for one or more guidelines, indications of how widely given guidelines are being implemented within a given construction project and/or within a given party, among other examples. The statistics may take other forms as well.

As yet another possibility, the disclosed software-based AI architecture may be used to create and verify the compliance of guidelines that extend beyond checking the form and substance of data objects. For instance, one such guideline may be used to ensure that a daily log data object is created every day by a given time, such as by 6 pm. Further, in the event that the guideline verification agent determines that the guideline is not being met, then the guideline verification agent may cause a notification to be presented to a user responsible for creating the daily log, e.g., prompting the user to create the daily log. There may be various other types of guidelines that extend beyond checking the form and substance of data objects. Further, these types of guidelines may be checked at various times and/or in response to various trigger events. As one example, the guideline verification agent may be configured to determine whether such guidelines are being complied with on a scheduled basis (e.g., every day at 6 pm, or according to some other schedule). As another example, the guideline verification agent may be configured to determine whether such guidelines are being complied with according to a trigger event, such as when a user begins logging off of the construction management software application, when a deadline is about to pass, when a task is completed, and/or when certain workflows or the like are executed, among various other possible trigger events. In line with the previous discussion, the guideline verification agent may utilize one or more subagents to check whether these guidelines are being complied with.

As yet another possibility, the disclosed software-based AI architecture may include one or more orchestrator agents that are configured to evaluate and route incoming requests to the AI agents or subagents that are best suited to provide a response to the requests, and then use the output from the AI agents to facilitate providing responses to the incoming requests. To accomplish this, an orchestrator agent may utilize a generative AI model to evaluate the incoming requests and identify one or more AI agents that are best suited to process the incoming requests. For instance, the orchestrator may pass a natural language request or input string to a generate AI model along with a request for the model to identify the AI agent or subagent that is best suited to provide a response. After receiving a response indicating the one or more AI agents or subagent, the orchestrator agent may then route the incoming requests to the one or more AI agents or subagents. As one example, consistent with the discussion above, the computing platform 102 may utilize an orchestrator agent to determine the set of one or more refiner agents 430 to be used for a given data object. As another example, the guideline creator agent 208 or the guideline verification agent 210 may generally act as an orchestrator agent to determine which subagents to coordinate with for a given data object. Alternatively, either of these agents may utilize a separate orchestrator agent to make a determination of which subagents to coordinate with for a given data object. An orchestrator agent may be utilized in other areas of the disclosed software-based AI architecture and may perform various other functions as well.

Further, the disclosed software-based AI architecture may be used in other ways as well.

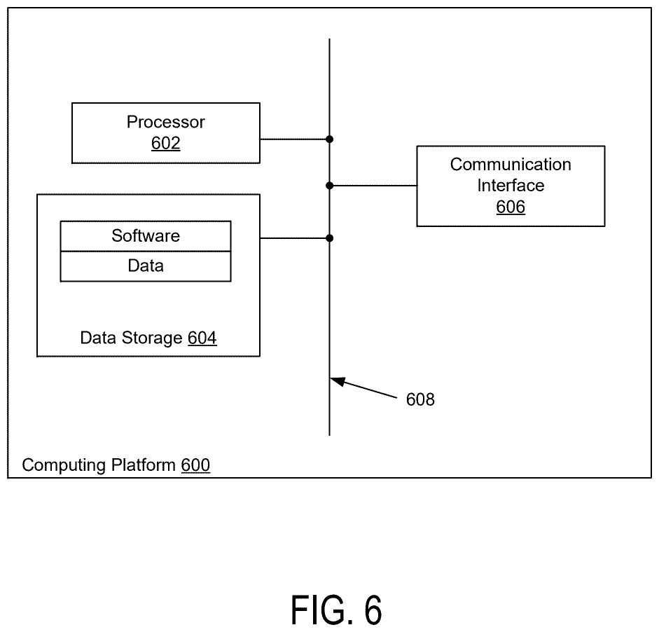

Turning now to FIG. 6, a simplified block diagram is provided to illustrate some structural components that may be included in an example computing platform 600 that may be configured to perform the platform-side functions disclosed herein. At a high level, the example computing platform 600 may generally comprise any one or more computer systems (e.g., one or more servers) that collectively include one or more processors 602, data storage 604, and one or more communication interfaces 606, each of which may be communicatively linked by a communication link 608 that may take the form of a system bus, a communication network such as a public, private, or hybrid cloud, or some other connection mechanism. Each of these components may take various forms.

For instance, the one or more processors 602 may comprise one or more processor components, such as one or more central processing units (CPUs), graphics processing units (GPUs), application-specific integrated circuits (ASICs), digital signal processor (DSPs), and/or programmable logic devices such as field programmable gate arrays (FPGAs), among other possible types of processing components. In line with the discussion above, it should also be understood that the one or more processors 602 could comprise processing components that are distributed across a plurality of physical computing devices connected via a network, such as a computing cluster of a public, private, or hybrid cloud.

In turn, the data storage 604 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that the data storage 604 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 6, the data storage 604 may be capable of storing both (i) program instructions that are executable by the one or more processors 602 such that the example computing platform 600 is configured to perform any of the various functions disclosed herein (including but not limited to any of the platform-side functions discussed above), and (ii) data that may be received, derived, or otherwise stored by the example computing platform 600.

The one or more communication interfaces 606 may comprise one or more interfaces that facilitate communication between the example computing platform 600 and other systems or devices, where each such interface may be wired and/or wireless and may communicate according to any of various communication protocols. As examples, the one or more communication interfaces 606 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

Although not shown, the example computing platform 600 may additionally have an Input/Output (I/O) interface that includes or provides connectivity to I/O components that facilitate user interaction with the example computing platform 600, such as a keyboard, a mouse, a trackpad, a display screen, a touch-sensitive interface, a stylus, a virtual-reality headset, and/or one or more speaker components, among other possibilities.

It should be understood that the example computing platform 600 is one example of a computing platform that may be used with the examples described herein. Numerous other arrangements are possible and contemplated herein. For instance, in other examples, the example computing platform 600 may include additional components not pictured and/or more or less of the pictured components.

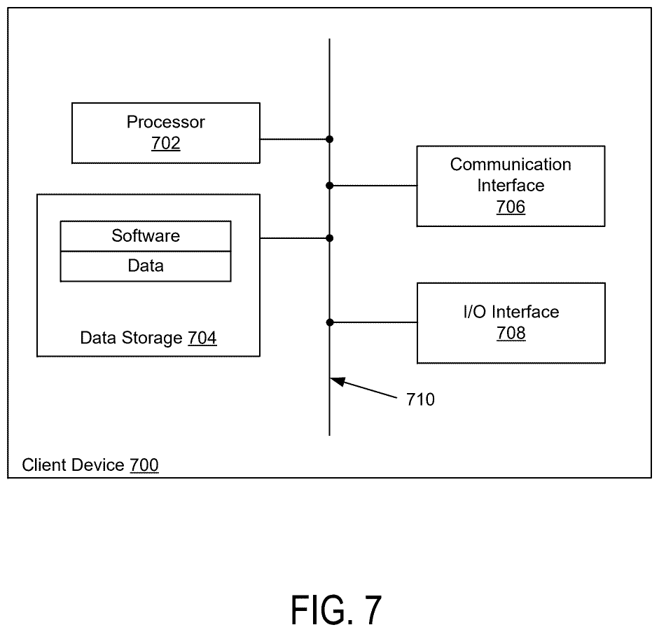

Turning next to FIG. 7, a simplified block diagram is provided to illustrate some structural components that may be included in an example client device 700 that may be configured to perform some of the client-side functions disclosed herein. At a high level, the example client device 700 may include one or more processors 702, data storage 704, one or more communication interfaces 706, and an I/O interface 708, each of which may be communicatively linked by a communication link 710 that may take the form a system bus and/or some other connection mechanism. Each of these components may take various forms.

For instance, the one or more processors 702 of the example client device 700 may comprise one or more processor components, such as one or more CPUs, GPUs, ASICs, DSPs, and/or programmable logic devices such as FPGAs, among other possible types of processing components.

In turn, the data storage 704 of the example client device 700 may comprise one or more non-transitory computer-readable mediums, examples of which may include volatile storage mediums such as random-access memory, registers, cache, etc. and non-volatile storage mediums such as read-only memory, a hard-disk drive, a solid-state drive, flash memory, an optical-storage device, etc. As shown in FIG. 7, the data storage 704 may be capable of storing both (i) program instructions that are executable by the one or more processors 702 of the example client device 700 such that the example client device 700 is configured to perform any of the various functions disclosed herein (including but not limited to any of the client-side functions discussed above), and (ii) data that may be received, derived, or otherwise stored by the example client device 700.

The one or more communication interfaces 706 may comprise one or more interfaces that facilitate communication between the example client device 700 and other systems or devices, where each such interface may be wired and/or wireless and may communicate according to any of various communication protocols. As examples, the one or more communication interfaces 706 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

The I/O interface 708 may generally take the form of (i) one or more input interfaces that are configured to receive and/or capture information at the example client device 700 and (ii) one or more output interfaces that are configured to output information from the example client device 700 (e.g., for presentation to a user). In this respect, the one or more input interfaces of I/O interface may include or provide connectivity to input components such as a microphone, a camera, a keyboard, a mouse, a trackpad, a touchscreen, and/or a stylus, among other possibilities, and the one or more output interfaces of the I/O interface 708 may include or provide connectivity to output components such as a display screen and/or an audio speaker, among other possibilities.

It should be understood that the example client device 700 is one example of a client device that may be used with the examples described herein. Numerous other arrangements are possible and contemplated herein. For instance, in other examples, the example client device 700 may include additional components not pictured and/or more or fewer of the pictured components.

Examples of the disclosed innovations have been described above. Those skilled in the art will understand, however, that changes and modifications may be made to the examples described without departing from the true scope and spirit of the present invention, which will be defined by the claims.

Further, to the extent that examples described herein involve operations performed or initiated by actors, such as “humans,” “operators,” “users,” or other entities, this is for purposes of example and explanation only. The claims should not be construed as requiring action by such actors unless explicitly recited in the claim language.

1. A computing platform comprising:
at least one processor;
at least one non-transitory computer-readable medium; and
program instructions stored on the at least one non-transitory computer-readable medium that, when executed by the at least one processor, cause the computing platform to:
receive an indication of a set of data element values for a new data object to be created within a construction management software application;
determine a set of guidelines for the new data object, each guideline of the set of guidelines corresponding to a respective data element of the new data object;
cause a guideline verification agent to:
determine, based on at least one of a software tool of the construction management software application used to create the new data object, a type of the new data object, or the data elements represented by the set of data element values, a set of subagents from among a plurality of subagents configured for different software tools, data-object types, data elements, or subject matters;
generate, in coordination with the determined set of subagents, a prompt comprising the set of data element values, the set of guidelines, and instructions to apply the set of guidelines to the new data object on a data-element-by-data-element basis;
provide the prompt to a generative artificial-intelligence model; and
receive, from the generative artificial-intelligence model, a response identifying one or more guidelines of the set of guidelines that are not satisfied by the new data object;
based on an evaluation of at least one of the new data object, a software tool of the construction management software application used to create the new data object, or the set of guidelines, select a set of refiner agents from a plurality of refiner agents configured for different software tools, data-object types, data elements, or subject matters, wherein different refiner agents of the plurality of refiner agents are configured to access differently trained generative artificial-intelligence models;
provide, to each refiner agent of the selected set of refiner agents, (i) the new data object, (ii) at least one guideline identified by the response, and (iii) a respective instruction to correct at least one data element value of the new data object;
cause the selected set of refiner agents to use one or more generative artificial-intelligence models to generate respective corrections to one or more data element values of the new data object based on the one or more guidelines identified by the response and the respective instructions;
generate a corrected data object by replacing the one or more data element values with the respective corrections; and
cause the guideline verification agent to reapply the set of guidelines to the corrected data object on the data-element-by-data-element basis to verify that the corrected data object complies with the set of guidelines.

2. (canceled)

3. The computing platform of claim 1, wherein each guideline of the set of guidelines comprises (i) a title, (ii) a rule, and (iii) a scoring criterion.

4. The computing platform of claim 1, further comprising program instructions stored on the at least one non-transitory computer-readable medium that, when executed by the at least one processor, cause the computing platform to:
cause an indication of a score of the new data object to be presented to a user of a client device, wherein the indication of the score indicates that the new data object is not in compliance with the set of guidelines; and
cause an indication of a recommendation for bringing the new data object into compliance with the set of guidelines to be presented to the user of the client device.

5-8. (canceled)

9. The computing platform of claim 1, further comprising program instructions stored on the at least one non-transitory computer-readable medium that, when executed by the at least one processor, cause the computing platform to:
after generating the corrected data object, cause the corrected data object to be stored within a data store accessible to the computing platform.

10. The computing platform of claim 1, further comprising program instructions that, when executed by the at least one processor, cause the computing platform to:
utilize a guideline creation agent to create the set of guidelines.

11. A non-transitory computer-readable medium, wherein the non-transitory computer-readable medium is provisioned with program instructions that, when executed by at least one processor, cause a computing platform to:
receive an indication of a set of data element values for a new data object to be created within a construction management software application;
determine a set of guidelines that correspond to for the new data object, each guideline of the set of guidelines corresponding to a respective data element of the new data object;
cause a guideline verification agent to:
determine, based on at least one of a software tool of the construction management software application used to create the new data object, a type of the new data object, or the data elements represented by the set of data element values, a set of subagents from among a plurality of subagents configured for different software tools, data-object types, data elements, or subject matters;
generate, in coordination with the determined set of subagents, a prompt comprising the set of data element values, the set of guidelines, and instructions to apply the set of guidelines to the new data object on a data-element-by-data-element basis;
provide the prompt to a generative artificial-intelligence model; and
receive, from the generative artificial-intelligence model, a response identifying one or more guidelines of the set of guidelines that are not satisfied by the new data object;
based on an evaluation of at least one of the new data object, a software tool of the construction management software application used to create the new data object, or the set of guidelines, select a set of refiner agents from a plurality of refiner agents configured for different software tools, data-object types, data elements, or subject matters, wherein different refiner agents of the plurality of refiner agents are configured to access differently trained generative artificial-intelligence models;
provide, to each refiner agent of the selected set of refiner agents, (i) the new data object, (ii) at least one guideline identified by the response, and (iii) a respective instruction to correct at least one data element value of the new data object;
cause the selected set of refiner agents to use one or more generative artificial-intelligence models to generate respective corrections to one or more data element values of the new data object based on the one or more guidelines identified by the response and the respective instructions;
generate a corrected data object by replacing the one or more data element values with the respective corrections; and
cause the guideline verification agent to reapply the set of guidelines to the corrected data object on the data-element-by-data-element basis to verify that the corrected data object complies with the set of guidelines.

12. (canceled)

13. The non-transitory computer-readable medium of claim 11, wherein each guideline of the set of guidelines comprises (i) a title, (ii) a rule, and (iii) a scoring criterion.

14. The non-transitory computer-readable medium of claim 11, wherein the non-transitory computer-readable medium is further provisioned with program instructions that, when executed by the at least one processor, cause the computing platform to:
cause an indication of a score of the new data object to be presented to a user of a client device, wherein the indication of the score indicates that the new data object is not in compliance with the set of guidelines; and
cause an indication of a recommendation for bringing the new data object into compliance with the set of guidelines to be presented to the user of the client device.

15-18. (canceled)

19. The non-transitory computer-readable medium of claim 11, wherein the non-transitory computer-readable medium is further provisioned with program instructions that, when executed by the at least one processor, cause the computing platform to:
utilize a guideline creation agent to create the set of guidelines.

20. A method carried out by a computing platform, the method comprising:
receiving an indication of a set of data element values for a new data object to be created within a construction management software application;
determining a set of guidelines that correspond to for the new data object, each guideline of the set of guidelines corresponding to a respective data element of the new data object;
causing a guideline verification agent to:
determine, based on at least one of a software tool of the construction management software application used to create the new data object, a type of the new data object, or the data elements represented by the set of data element values, a set of subagents from among a plurality of subagents configured for different software tools, data-object types, data elements, or subject matters;
generate, in coordination with the determined set of subagents, a prompt comprising the set of data element values, the set of guidelines, and instructions to apply the set of guidelines to the new data object on a data-element-by-data-element basis;
provide the prompt to a generative artificial-intelligence model; and
receive, from the generative artificial-intelligence model, a response identifying one or more guidelines of the set of guidelines that are not satisfied by the new data object;
based on an evaluation of at least one of the new data object, a software tool of the construction management software application used to create the new data object, or the set of guidelines, selecting a set of refiner agents from a plurality of refiner agents configured for different software tools, data-object types, data elements, or subject matters, wherein different refiner agents of the plurality of refiner agents are configured to access differently trained generative artificial-intelligence models;
providing, to each refiner agent of the selected set of refiner agents, (i) the new data object, (ii) at least one guideline identified by the response, and (iii) a respective instruction to correct at least one data element value of the new data object;
causing the selected set of refiner agents to use one or more generative artificial-intelligence models to generate respective corrections to one or more data element values of the new data object based on the one or more guidelines identified by the response and the respective instructions;
generating a corrected data object by replacing the one or more data element values with the respective corrections; and
causing the guideline verification agent to reapply the set of guidelines to the corrected data object on the data-element-by-data-element basis to verify that the corrected data object complies with the set of guidelines.

21. The computing platform of claim 1, wherein the respective instruction provided to a given refiner agent of the selected set of refiner agents includes a respective indication identifying which one or more data element values of the new data object the given refiner agent is to correct.

22. The computing platform of claim 1, wherein a given refiner agent of the selected set of refiner agents is configured to determine, based on a given configuration of the given refiner agent, which one or more data element values of the new data object to correct.

23. The computing platform of claim 1, wherein the program instructions that, when executed by the at least one processor, cause the computing platform to cause the selected set of refiner agents to use the one or more generative artificial-intelligence models comprise program instructions that, when executed by the at least one processor, cause the computing platform to cause each refiner agent of the selected set of refiner agents to (i) generate a respective refiner prompt comprising (a) at least one data element value of the new data object to be corrected, (b) the at least one guideline provided to the refiner agent, and (c) the respective instruction provided to the refiner agent, and (ii) provide the respective refiner prompt to a generative artificial-intelligence model accessible to the refiner agent.

24. The computing platform of claim 1, wherein:
the selected set of refiner agents comprises (i) a first refiner agent configured to access a first generative artificial-intelligence model trained to generate a first type of correction and (ii) a second refiner agent configured to access a second generative artificial-intelligence model trained to generate a second type of correction different from the first type of correction;
the program instructions that, when executed by the at least one processor, cause the computing platform to cause the selected set of refiner agents to use one or more generative artificial-intelligence models to generate respective corrections to one or more data element values of the new data object comprise program instructions that, when executed by the at least one processor, cause the computing platform to (i) cause the first refiner agent to use the first generative artificial-intelligence model to generate a first correction to a first data element value of the new data object and (ii) cause the second refiner agent to use the second generative artificial-intelligence model to generate a second correction to a second data element value of the new data object; and
the program instructions that, when executed by the at least one processor, cause the computing platform to generate the corrected data object comprise program instructions that, when executed by the at least one processor, cause the computing platform to generate the corrected data object at least in part by replacing the first data element value with the first correction and replacing the second data element value with the second correction.

25. The method of claim 20, further comprising:
utilizing a guideline creation agent to create the set of guidelines.

26. The method of claim 20, wherein the respective instruction provided to a given refiner agent of the selected set of refiner agents includes a respective indication identifying which one or more data element values of the new data object the given refiner agent is to correct.

27. The method of claim 20, wherein a given refiner agent of the selected set of refiner agents is configured to determine, based on a given configuration of the given refiner agent, which one or more data element values of the new data object to correct.

28. The method of claim 20, wherein causing the selected set of refiner agents to use the one or more generative artificial-intelligence models comprises:
causing each refiner agent of the selected set of refiner agents to (i) generate a respective refiner prompt comprising (a) at least one data element value of the new data object to be corrected, (b) the at least one guideline provided to the refiner agent, and (c) the respective instruction provided to the refiner agent, and (ii) provide the respective refiner prompt to a generative artificial-intelligence model accessible to the refiner agent.

29. The method of claim 20, wherein:
the selected set of refiner agents comprises (i) a first refiner agent configured to access a first generative artificial-intelligence model trained to generate a first type of correction and (ii) a second refiner agent configured to access a second generative artificial-intelligence model trained to generate a second type of correction different from the first type of correction;
causing the selected set of refiner agents to use one or more generative artificial-intelligence models to generate respective corrections to one or more data element values of the new data object comprises:
causing the first refiner agent to use the first generative artificial-intelligence model to generate a first correction to a first data element value of the new data object; and
causing the second refiner agent to use the second generative artificial-intelligence model to generate a second correction to a second data element value of the new data object; and
generating the corrected data object comprises:
generating the corrected data object at least in part by replacing the first data element value with the first correction and replacing the second data element value with the second correction.

30. The method of claim 20, further comprising:
causing an indication of a score of the new data object to be presented to a user of a client device, wherein the indication of the score indicates that the new data object is not in compliance with the set of guidelines; and
causing an indication of a recommendation for bringing the new data object into compliance with the set of guidelines to be presented to the user of the client device.
